(19) United States
(12) Patent Application Publication
(10) Pub. No.: US 2004/0086728 A1
(43) Pub. Date: May 6, 2004

(54) Plated product and production method of plated product

(76) Inventors: Yosuke Maruoka, Aichi-ken (JP); Yukitaka Hasegawa, Aichi-ken (JP); Yasuhiko Ogisu, Aichi-ken (JP); Hiroshi Watari, Aichi-ken (JP)

Correspondence Address: POSZ & BETHARDS, PLC, 11250 ROGER BACON DRIVE, SUITE 10, RESTON, VA, 20190, US

(21) Appl. No.: 10/682,884

(22) Filed: Oct. 14, 2003

(30) Foreign Application Priority Data
Oct. 31, 2002 (JP) 2002-318772
Apr. 16, 2003 (JP) 2003-112082

(51) Int. Cl. B32B 9/04

(52) U.S. Cl. 428/447; 428/457

(57) ABSTRACT

A plated product has a base layer, a silver plating layer, and a top coat layer. The top coat layer is consisted of an acrylic silicone coating that includes a primary agent and a curing agent. A coating film is formed by causing the primary agent and the curing agent to react while the acrylic silicone coating is applied to the metal plating layer. When the coating film is aged by allowing to stand for 240 hours at a normal temperature and a humidity range of 20% to 70%, the range of the glass transition temperature of the coating film is between 70° C. and 120° C. inclusive. The plated product has superior weather resistance.

### BACKGROUND OF THE INVENTION

The present invention relates to a plated product provided with at least a metal plating layer and a covering layer that covers the surface of the metal plating layer on the surface of a base layer.

Japanese Laid-Open Patent Publication No. 10-309774, for example, discloses a plated product provided with a base layer, an undercoat layer as a substrate layer, a silver plating layer, and a top coat layer as a covering layer. An alkyd resin coating or urethane resin coating, for example, is used for the undercoat layer. The silver plating layer is laminated onto the surface of the undercoat layer by chemically precipitating silver from an aqueous solution containing silver using the silver mirror reaction. An alkyd-denatured silicone resin coating or acrylic-denatured silicone resin coating, for example, is used for the top coat layer.

Japanese Laid-Open Patent Publication No. 2001-164380, for example, discloses a plated product provided with two top coat layers on a silver plating layer using the silver mirror reaction for the purpose of improving appearance by inhibiting surface irregularities. In this constitution, the top coat layer has an undercoating layer and an over coating layer. The undercoating layer is composed of a urethane coating having for its main components isocyanate and an epoxy resin, and is coated onto the silver plating layer and dried without blending a curing agent therein. Next, an over coating layer composed of a urethane coating having for its main components isocyanate and an epoxy resin is coated onto the undercoating layer in the state in which a curing agent is blended therein. The undercoating layer and over coating layer are cured by the action of the curing agent.

When the plated product is used in an accelerated weather resistance test, the silver plating layer is corroded and gradually whitens, causing the appearance of the plated product to take on a yellowish tint. An acrylic silicone resin is used for the top coat layer to improve the moisture resistance of the top coat layer. However, in the case of simply using an acrylic silicone resin coating for the top coat layer, even if whitening of the silver plating layer can be inhibited, yellowing of the plated product is not sufficiently inhibited.

The acrylic silicone resin has a betaine structure (—N+RR′—CO—) that is formed by the reaction between an amino group bonded to the main chain of the acrylic resin and a glycidyl group of a silane coupling agent serving as the curing agent. The betaine structure has a nitrogen atom charged to δ+, and has the property of facilitating the coordination of hydroxide ions contained in water that has penetrated inside the coating film serving as the top coat layer. Although the acrylic silicone resin itself has comparatively high moisture resistance, if adequate moisture resistance is not imparted to the coating film formed by the acrylic silicone resin, there is the risk of the occurrence of the coordination of hydroxide ions to the nitrogen ion by water that has penetrated into the top coat layer. Yellowing of the plated product is presumed to occur due to this coordination.

In the case of the plated product disclosed in the Japanese Laid-Open Patent Publication No. 2001-164380, it is necessary to apply the top coat layer twice. Consequently, the number of coating steps increases, complicating the operation. In addition, in the case of only forming two top coat layers simply using a urethane coating, it is difficult to impart high degrees of moisture resistance and weather resistance as is required by automotive parts, for example.

### SUMMARY OF THE INVENTION

An object of the present invention is to provide a plated product that can be produced by a simple coating process and has superior weather resistance.

To attain the above object, the present invention provides a plated product. The plated product has a substrate layer, a metal plating layer and a covering layer. The metal plating layer is located on the substrate layer. The covering layer covers a surface of the metal plating layer. The covering layer is consisted of an acrylic silicone coating that includes a primary agent and a curing agent. A coating film is formed by causing the primary agent and the curing agent to react while the acrylic silicone coating is applied to the metal plating layer. When the coating film is aged by allowing to stand for 240 hours at a normal temperature and a humidity range of 20% to 70%, the range of the glass transition temperature of the coating film is between 70° C. and 120° C. inclusive.

The present invention also provides a production method of a plated product. The method includes preparing a substrate layer; forming a metal plating layer on a substrate of the substrate layer; applying an acrylic silicone coating including a primary agent and a curing agent on a surface of the metal plating layer, wherein a coating film is formed by causing the primary agent and the curing agent to react, wherein the coating film is aged by allowing to stand for 240 hours at a normal temperature and a humidity range of 20% to 70% such that the range of the glass transition temperature of the coating film is between 70° C. and 120° C. inclusive.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a cross-sectional view schematically showing a portion of a plated product in a first embodiment of the present invention.

FIG. 2 is a flow chart relating to the production method of the plated product of FIG. 1.

### DETAILED DESCRIPTION OF THE EMBODIMENTS

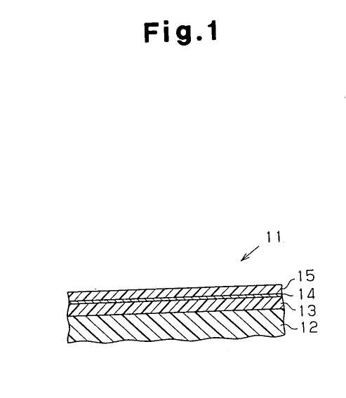

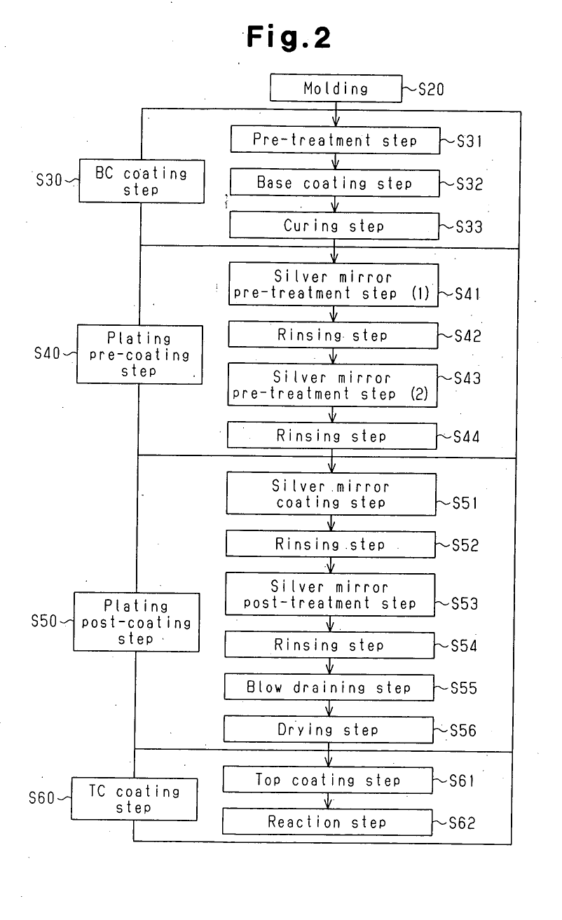

The following provides an explanation of an embodiment of the present invention based on FIGS. 1 and 2.

As shown in FIG. 1, a substrate layer in the form of a base coat layer 13, a metal plating layer in the form of a silver plating layer 14, and a covering layer in the form of a top coat layer 15 are formed on the surface (design surface) of a synthetic resin base layer 12 in a plated product 11.

The base layer 12 is composed of, for example, acrylonitrile-butadiene-styrene copolymer (ABS), polycarbonate (PC), PC/ABS alloy, polypropylene (PP), polymethyl methacrylate (PMMA), or thermoplastic olefin (TPO), and is formed, for example, by a known injection molding method.

The base coat layer 13 is laminated by coating or immersing a base coating agent onto the surface of the base layer 12 followed by allowing to react. For example, a two-liquid cured polyurethane resin having an alkyd-denatured acrylic polyol for its primary agent and a burette type of hexamethylene diisocyanate (HDMI) for its curing agent, is preferably used for the base coating agent.

In order to carry a co-catalyst in the form of tin[II] on the base coat layer 13 prior to formation of the silver plating layer 14, a first pretreatment liquid containing tin[II] chloride and hydrochloric acid is coated onto the base coat layer 13. Furthermore, polyvalent alcohols such as glucose (D-glucose) and glycerin may also be added to the first pretreatment liquid to inhibit oxidation of tin[II].

After rinsing the base coat layer 13, a palladium[II] chloride solution is coated onto the base coat layer 13 carried with a co-catalyst. As a result, palladium[II] is carried on the surface of the base coat layer 13 to serve as a catalyst that promotes the initial nucleus formation of the silver of the silver plating layer 14.

The silver plating layer 14 is laminated onto the surface of the base coat layer 13 by a chemical plating method that utilizes the silver mirror reaction (electroless plating). More specifically, an ammoniacal silver nitrate ([Ag(NH₃)₂]+OH⁻) solution and a reducing agent solution are coated so as to be mixed on the surface of the base coat layer 13, after which silver (Ag) precipitates in the form of a metal due to the ensuing reduction-oxidation reaction. Aqueous solutions of organic compounds (R—CHO) having an aldehyde group such as glyoxal, hydrazine hydrate, sodium sulfite, or sodium thiosulfate and so forth are preferably used for the reducing agent solution.

Prior to forming the top coat layer 15 for protecting the silver plating layer 14, a post-treatment liquid consisting of a solution containing a monovalent alkyl alcohol or a reducing solution is coated onto the silver plating layer 14. Coating this post-treatment liquid improves the adhesive strength between the silver plating layer 14 and the top coat layer 15.

The top coat layer 15 is laminated by coating or immersing a top coating agent onto the surface of the silver plating layer 14 and then the top coating agent is allowed to react with the silver plating layer 14 in order to protect that silver plating layer 14. A highly water-repellent acrylic silicone resin is preferably used for the top coating agent.

After coating and reacting the acrylic silicone resin, the coating film of the top coat layer 15 is aged by allowing to stand for 240 hours at a normal temperature (20° C.±15° C. in compliance with JIS B2061) and a humidity (RH) range of 20% to 70%. As a result of this aging, crosslinking further proceeds within the coating film, and the range of the glass transition temperature (Tg) of the coating film is adjusted to 70° C. to lower than 120° C., preferably 70° C. to 110° C., and more preferably 70° C. to 105° C. If the Tg of the coating film after aging is lower than 70° C., moisture resistance of the top coat layer 15 tends to be inadequate, and yellowing inhibitory effect becomes inadequate under conditions of accelerated weather resistance testing. On the other hand, if the Tg of the coating film after aging is 120° C. or higher, although moisture resistance becomes high, curing of the coating film and contraction during aging become excessively large, thereby causing decreased adhesion to the silver plating layer.

The acrylic silicone resin contains an acrylic resin solution serving as the primary agent and a silane coupling agent serving as a curing agent. The range of the Tg of the acrylic resin serving as the primary resin is preferably from 35° C. to 80° C., more preferably from 40° C. to 60° C., and even more preferably from 45° C. to 58° C. As a result, making the Tg of the acrylic resin 35° C. or higher, it becomes easy to adjust the Tg of its coating film after aging to be within the range of 70° C. to less than 120° C. after aging for a predetermined amount of time when the coating film is formed on the top coat layer 15.

The range of the amount of amine of the acrylic resin is preferably from more than 5 wt % to less than 20 wt %, more preferably from 7 wt % to 15 wt %, and even more preferably from 9 wt % to 13 wt %. If the amount of amine of the acrylic resin is decreased, the number of betaine structures in the top coat layer 15 can be decreased. However, accompanying this decrease in the number of betaine structures, the number of crosslinked points between the acrylic main chain and crosslinking structures that crosslink with the main chain and have a siloxane bond that imparts moisture resistance to the top coat layer 15 also decreases. In the case where the amount of amine of the acrylic resin is 5 wt % or less, the number of crosslinked points decreases excessively, resulting in the risk of a decrease in moisture resistance of the top coat layer 15. On the other hand, in the case where the amount of amine is 20 wt % or more, the number of betaine structures in the acrylic silicone resin formed as the top coat layer 15 increases, and hydroxide ions contained in water that has penetrated within the top coat layer 15 more easily coordinate to nitrogen atoms of the betaine structures. Consequently, the effect of inhibiting yellowing under conditions of accelerated weather resistance testing may be inadequate.

The curing agent preferably contains a silane coupling agent and alkoxysilane. The silane coupling agent is expressed as X—R′—O—R″—Si(OR)₃ (wherein R′ and R″ each are an alkyl group). The position of X is an epoxy group, and the position of OR is an alkoxy group. In addition, the range of the ratio of the alkoxysilane to the silane coupling agent is preferably more than 0.2 to less than 15, more preferably from 0.5 to 10, and even more preferably from 0.7 to 5. Examples of the silane coupling agents include 3-glycidoxypropyltrimethoxysilane (GPMS) and 3-glycidoxypropyltriethoxysilane. In addition, examples of alkoxysilanes include tetraethoxysilane (TES), polytetraethoxysilane, tetramethoxysilane, polytetramethoxysilane, tetrapropoxysilane, and tetrabutoxysilane.

In the case where the ratio of alkoxysilane to the silane coupling agent is 0.2 or less, the crosslinking density of the coating film is unable to be made adequately high, and water penetrates easily into the top coat layer 15. Consequently, weather resistance and moisture resistance are unable to be adequately enhanced, and there is the risk of the occurrence of yellowing in the plated product 11 under conditions of accelerated weather resistance testing. On the other hand, in the case where the ratio of the alkoxysilane to the silane coupling agent is 15 or more, the crosslinking density of the acrylic silicone resin that composes the coating film becomes excessively high, resulting in the risk of the occurrence of whitening of the plated product 11.

In addition, a contraction relaxant that alleviates contraction during curing of the coating film may be added to the acrylic resin solution. Examples of contraction relaxants include acrylic lacquers such as methyl methacrylate (MMA) and acrylic polyols. In this manner, by adding a contraction relaxant, contraction of the coating film during curing and aging of the top coat layer 15 is alleviated, thereby the adhesion is satisfactorily maintained between the top coat layer 15 and the silver plating layer 14.

Moreover, an ultraviolet absorber may be added to the acrylic resin solution. Preferably, the ultraviolet absorber does not have a hydroxyl group in its molecule. Examples of ultraviolet absorbers that have no hydroxyl group in their molecules include anilide oxalate-based ultraviolet absorbers.

Triazine-based ultraviolet absorbers are also preferable for the ultraviolet absorber. Although triazine-based ultraviolet absorbers may have up to two hydroxyl groups in their molecules, the fewer the number of hydroxyl groups the better. Examples of triazine-based ultraviolet absorbers include Ciba TINUVIN 400 manufactured by Ciba Specialty Chemicals.

In the case of adding an ultraviolet absorber having a hydroxyl group (excluding triazine-based ultraviolet absorbers), the hydroxyl group of the ultraviolet absorber itself coordinates to the nitrogen in the betaine structure of the acrylic silicone resin, thereby resulting in the risk of a decrease in yellowing inhibitory effect under conditions of accelerated weather resistance testing.

In addition, a hindered amine light stabilizer (HALS) may be added to the acrylic resin solution. HALS is able to particularly improve the weather resistance of the top coat layer 15 by being present with the ultraviolet absorber. The HALS particularly preferably does not have a hydroxyl group in its molecule. Examples of HALS include Ciba TINUVIN 144 manufactured by Ciba Specialty Chemicals. A specific example of HALS having no hydroxyl group in its molecule is Ciba TINUVIN 123 manufactured by Ciba Specialty Chemicals.

In the case of adding HALS having a hydroxyl group, the hydroxyl group of the HALS itself coordinates to the nitrogen in the betaine structure of the acrylic silicone resin, resulting in the risk of lowering yellowing inhibitory effect under conditions of accelerated weather resistance testing.

Next, the following provides a description of a production method of the plated product 11.

As shown in FIG. 2, during the production of plated product 11, after first carrying out injection molding of the base layer 12 to a predetermined shape in step S20, the base coat coating step (BC coating step) of step S30 is carried out.

In the BC coating step, the surface (design surface) of the base layer 12 following the molding is first adequately cleaned using a cleaning agent, such as isopropanol, in the pretreatment step of step S31. Subsequently, in the base coating step of step S32, a base coating agent is uniformly coated onto the design surface of the base layer 12 following the cleaning. Although any coating or immersion method may be used for the coating method of the base coating agent in step S32, spray coating is preferable since coating can be carried out easily. Examples of base coating agents that are used preferably include “771” manufactured by Ohashi Chemical Industries, or “E-1” manufactured by Origin Electric. “771” is a two-liquid cured urethane coating in which the main chain of the primary agent is acrylic polyol (70%), while the branched chain is alkyd polyol (30%), burette-type HMDI is used for the curing agent, and the NCO/OH ratio is 1/1. In addition, “E-1” is an epoxy coating in which the primary agent is epoxy resin and an amine compound is used for the curing agent.

Subsequently, in the curing step of step S33, the base coating agent coated onto the design surface of the base layer 12 is allowed to react and be cured. In the case of using the “E-1” for the base coating agent, the reaction is carried out at a temperature of 80° C. for 60 minutes. In the case of using the “771” for the base coating agent, the reaction is carried out at 80° C. for 30 minutes. After carrying out the curing step of step S33, the process goes to the plating pre-coating step of step S40.

In the plating pre-coating step of step S40, in order to facilitate precipitation of silver in the plating post-coating step of step S50, pretreatment consisting of steps S41 through S44 is carried out on the surface of the base coat layer 13. In the silver mirror pretreatment step (1) of step S41, a first pretreatment solution containing a co-catalyst is coated or immersed onto the surface of the base coat layer 13 after the layer is dried, and this co-catalyst is carried on the surface of the base coat layer 13. Tin[II], for example, is preferably used for the co-catalyst, and tin[II] chloride (SnCl₂) solution containing hydrochloric acid is preferably used for the first pretreatment solution.

A polyvalent alcohol such as glucose (D-glucose) or glycerin may be added to the first pretreatment solution to inhibit oxidation of tin[II]. The amount of polyvalent alcohol added is preferably at least equal to the number of moles of hydrochloric acid in the solution. Examples of polyvalent alcohols that may be used in addition to glucose (D-glucose) and glycerin include 1,3-propanediol, 1,2-propanediol, ethylene glycol, erythritol, D-erythrulose, D-erythrose, D-threose, D-arabinose, β-D-arabinose β-L-arabinose, D-xylulose, L-xylulose, D-xylose, α-D-xylose, 2-deoxy-D-ribose, 2-deoxy-β-D-ribose, D-lyxose, α-D-lyxose, α-L-lyxose, D-ribulose, D-ribose, D-arabilol, ribitol D-altrose, β-D-altrose, D-allose, β-D-allose, D-idose, D-galactose, α-D-galactose, β-D-galactose, α-L-galactose, D-quinovose, α-D-quinovose, α-D-glucose, β-D-glucose, α-cyclodextrin, and β-cyclodextrin.

Subsequently, in the rinsing step of step S42, the surface of the base coat layer 13 is rinsed using ion exchange water or distilled water (preferably having conductivity of 3 μS/m or less) to remove excess tin[II] chloride not carried on the surface of the base coat layer 13.

Next, in the silver mirror pretreatment step (2) of step S43, a second pretreatment solution containing a catalyst is coated or immersed onto the surface of the dried base coat layer 13, and as a result of replacing the co-catalyst, the catalyst is carried on the surface of the base coat layer 13. Palladium[II], for example, is preferably used for the catalyst carried on the surface of the base coat layer 13. In addition, palladium[II] chloride (PdCl₂) solution or “Activator” manufactured by Okuno Pharmaceutical is preferably used for the second pretreatment solution. In this manner, a catalyst that promotes initial nucleus formation of the silver of the silver plating layer 14 is carried on the surface of the base coat layer 13. In the plating pre-coating step, the carrying of palladium[II] on substrate on which the plating layer is formed as a catalyst is the same as the case of forming a nickel plating layer.

Subsequently, in the rinsing step of step S44, the surface of the base coat layer 13 is rinsed using ion exchange water or distilled water (preferably having conductivity of 3 μS/m or less) to remove excess palladium[II] chloride that was not carried on the surface of the base coat layer 13.

After carrying out the plating pre-coating step of step S40 by the process, the plating post-coating step of step S50 is performed. In this plating post-coating step, formation of silver plating layer 14 and post-treatment of the silver plating layer 14 are carried out using the silver mirror reaction contained in steps S51 through S56 indicated below.

First, in the silver mirror coating step of step S51, an ammoniacal silver nitrate solution and a reducing agent solution are simultaneously coated onto the surface of base coat layer 13, carried on with the catalyst. Silver is precipitated by reacting with both solutions on the base coat layer 13. The precipitated silver is laminated onto the surface of base coat layer 13 centering around the palladium[II] carried on the surface of the base coat layer 13, resulting in the formation of the silver plating layer 14. In this silver mirror coating step, “LA” or “LB” manufactured by Daitec is preferably used in this silver mirror coating step. In addition, the ammoniacal silver nitrate solution may be prepared by, for example, dissolving a predetermined amount of silver nitrate in ion exchange water to prepare an aqueous silver nitrate solution followed by dropping in aqueous ammonia to this aqueous silver nitrate solution until the brown precipitate of silver oxide disappears. Aqueous solutions of organic compounds having a glyoxal or other aldehyde group (R—CHO), hydrazine hydrate, sodium sulfite, or sodium thiosulfate, and so forth, are preferably used for the reducing agent solution.

It should be noted that in this silver mirror coating step, it is convenient to apply the ammoniacal silver nitrate solution and reducing agent solution using a dual nozzle spray gun or concentric nozzle spray gun.

Subsequently, in the rinsing step of step S52, the surface of the silver plating layer 14 is rinsed using ion exchange water or distilled water, and after removing any solution following the silver mirror reaction remaining on the surface of that silver plating layer 14, the silver mirror post-treatment step of step S53 is carried out.

In the silver mirror post-treatment step of step S53, a post-treatment solution is applied to the surface of the silver plating layer 14 to improve the adhesive strength with the top coat layer 15 formed in the top coating step of the following step S61.

A monovalent alkyl alcohol, for example, is used for the post-treatment solution of the silver plating layer 14. A monovalent alkyl alcohol differs from a phenol in which a hydroxyl group is bonded directly to an aromatic ring in that it is not acidic. Consequently, in step S53, the brightness of the mirrored surface is not lost by applying an alcohol to the surface of the silver plating layer 14.

An alcohol in which the number of carbon atoms of the alkyl group is 4 or less is preferably used for the alcohol. Since alcohol has a high solubility with respect to water, the concentration of alcohol applied to the surface of silver plating layer 14 can be adjusted easily. Moreover, since an alcohol dissolves easily in water, the surface of the silver plating layer 14 is rinsed easily after treating the silver plating layer 14 with an alcohol.

Specific examples of alcohols used for post-treatment of the silver plating layer 14 include methanol, ethanol, propanol, and butanol. It should be noted that the alkyl groups of methanol, ethanol, propanol, or butanol may be bonded in the state where the carbon atoms are arranged in the form of a single straight chain or they may be bonded in which the carbon atoms are branched from a single straight chain.

As a result of coating the alcohol onto the silver plating layer 14, hydroxyl groups having an extremely high degree of polarity are imparted to the surface of the silver plating layer 14.

A reducing solution may also be used for the post-treatment solution of the silver plating layer 14. Solutions containing a substance such as sulfurous acid, sulfite, or hydrogen sulfite are preferably used for the reducing solution. In addition, the reducing solution may also be a solution containing, for example, bivalent metal ions that have reducing properties similar to those of sulfite ions. More specifically, examples of bivalent metal salts having potent reducing properties include salts of Sn[II] and salts of Fe[II] . In addition, the reducing solution may also contain an organic acid, hydrazine, sodium borohydride, dimethylamine borane, sodium phosphinate, thiourea dioxide, hydrazinium chloride, L(+)-ascorbic acid, sodium thiosulfate, or aqueous hydrogen peroxide.

By applying these reducing solutions to the silver plating layer 14, the oxide film covering the surface of the silver plating layer 14 is rapidly reduced. As a result, hydroxyl groups, which are extremely highly polar functional groups, are imparted to the surface of the silver plating layer 14.

Next, in the rinsing step of step S54, after rinsing the surface of the silver plating layer 14 using ion exchange water or distilled water, in the blow draining step of step S55, water droplets adhered to the surface of the silver plating layer 14 are blown off with air. Subsequently, in the drying step of S56, after drying at a temperature of 70° C. for 30 minutes, the top coat coating step (TC coating step) of step S60 is carried out.

In the TC coating step of step S60, the top coat layer 15 composed of a top coating agent is formed on the surface of the silver plating layer 14. First, in the top coating step of step S61, a top coating agent is uniformly applied to the surface of the silver plating layer 14. An acrylic silicone coating is preferably used for the top coating agent.

In the step S53, highly polar hydroxyl groups are imparted to the surface of the silver plating layer 14. Consequently, the number of bonding points is increased between the silver plating layer 14 and the top coat layer 15 formed in the TC coating step of step S60. As a result, intermolecular force resulting from interaction between polar groups is increased at the interface between the silver plating layer 14 and the top coat layer 15, thereby improving the adhesive strength between the silver plating layer 14 and the top coat layer 15.

Subsequently, in the reaction step of step S62, a plated product 11 coated with a top coating agent is allowed to stand for a predetermined amount of time under predetermined temperature conditions to allow the top coating agent coated onto the silver plating layer 14 to react and form a top coat layer 15. The plated product on which the top coat layer 15 has been formed is allowed to stand for 240 hours at normal temperature (20±15° C.) and humidity of 20% to 70% to promote crosslinking of the acrylic silicone resin.

Siloxane bonds that mutually connect silicon and nitrogen are formed at the interface between the silver plating layer 14, and the top coat layer 15 formed in this manner. The siloxane bonds are thermally and chemically stable inorganic bonds, and primarily form the basic skeleton of glass.

The plated product 11 can be preferably applied to automobile interior parts such as instrument panels, center panels, registers, center consoles, and emblems. In addition, the plated product 11 can also be preferably applied to automobile exterior parts such as hub caps, bumper moldings, wheel garnishing, radiator grilles, rear panels, and emblems. Moreover, the plated product 11 can also be preferably applied to various plated products used in applications other than automobiles such as air-conditioner housings, cell phones, and notebook personal computers.

The present embodiment offers the advantages indicated below.

(1) The top coat layer 15 of the plated product 11 is composed of an acrylic silicone resin coating. The acrylic silicone resin coating is blended so that, when coated onto the silver plating layer 14, the range of the Tg of the coating film itself of the top coat layer 15 after 240 hours have elapsed is from 70° C. to less than 120° C. As a result of blending in this manner, moisture resistance of the top coat layer 15 is improved, and the penetration of water into the top coat layer 15 is inhibited. Consequently, in addition to whitening of the silver plating layer 14 being inhibited as a result of inhibiting the coordination of hydroxyl ions with respect to nitrogen of the betaine structure possessed by the acrylic silicone resin, yellowing of the top coat layer 15 can also be inhibited. Moreover, in the formation of the top coat layer 15, a plated product can be produced with a simple coating process without requiring the application of two layers.

(2) The range of the Tg of the acrylic resin contained in the acrylic silicone resin coating is from 35° C. to 80° C. Within the range, the range of the Tg of the coating film that composes the top coat layer 15 can be easily controlled to 70° C. to less than 120° C.

(3) The range of the amount of amine of the acrylic resin is from 5 wt % to 20 wt %. When within this range, the number of betaine structures possessed by the acrylic silicone resin is reduced while maintaining moisture resistance of the top coat layer 15, and yellowing of the top coat layer 15 can be inhibited.

(4) In the acrylic silicone resin coating, the range of the ratio of alkoxysilane to a silane coupling agent is from 0.2 to 15. By blending the coating in this manner, the crosslinking density of the acrylic silicone resin coating that composes the top coat layer 15 is enhanced, and moisture resistance of the top coat layer 15 can be improved while inhibiting whitening of the plated product 11.

(5) The primary agent of the acrylic silicone resin coating contains a contraction relaxant that alleviates contraction during curing of the coating film. Consequently, contraction during curing of the coating film is alleviated, and the adhesion of the top coat layer 15 to the silver plating layer 14 can be improved. In particular, the effect of this contraction relaxant becomes more remarkable the higher the Tg of the coating film.

(6) The primary agent of the acrylic silicone resin coating contains an ultraviolet absorber that does not have a hydroxyl group in its molecule. Alternatively, the acrylic silicone resin contains a triazine-based ultraviolet absorber. Consequently, weather resistance of the top coat layer 15 can be improved while inhibiting coordination between hydroxide ions and the betaine structures possessed by the acrylic silicone resin.

(7) The primary agent of the acrylic silicone resin coating contains a hindered amine light stabilizer that does not have a hydroxyl group in its molecule. Consequently, the weather resistance of top coat layer 15 can be greatly improved by combining with an ultraviolet absorber not containing hydroxyl groups or triazine-based ultraviolet absorber in particular.

The following provides a more detailed explanation of the embodiment through examples and comparative examples.

### EXAMPLE 1

After injection molding a base layer 12 formed into the shape of a rectangular plate from ABS, the pretreatment step of step S31 was carried out by spray cleaning the surface (design surface) of the base layer 12 using isopropanol. Thereafter, the base coating step of step S32 was carried out by spray coating a base coating agent in the form of a two-liquid cured polyurethane resin (Origin Electric) onto the surface of the base layer 12. Subsequently, by carrying out the curing step of step S33 for 60 minutes in a drying oven at 80° C., a base coat layer 13 having a uniform thickness of about 20 μm was formed on the surface of the base layer 12.

Next, the silver mirror pretreatment step (1) of step S41 was carried out by spray coating a tin[II] chloride solution containing 3 wt % of tin[II] chloride and 1 wt % of hydrochloric acid onto the surface of the base coat layer 13. Subsequently, the rinsing step of step S42 was carried out by spray cleaning the surface of the base coat layer 13 using ion exchange water having conductivity of 3 μS/m or less. Subsequently, the silver mirror pretreatment step (2) of step S43 was carried out by spray coating palladium chloride solution (“Activator 5 wt % Solution”, Okuno Pharmaceutical). Then, the rinsing step of step S44 was carried out by spray cleaning the surface of the base coat layer 13 using ion exchange water having conductivity of 3 μS/m or less.

Subsequently, the silver mirror coating step of step S51 was carried out by simultaneously spraying a coating ammoniacal silver nitrate solution (“LA”, Daitec) and a reducing agent solution (“LB”, Daitec) onto the surface of the base coat layer 13 using a dual nozzle spray gun. As a result, a silver plating layer 14 having a uniform thickness of about 0.1 μm was formed on the surface of the base coat layer 13. Subsequently, the rinsing step of step S52 was carried out by spray cleaning the surface of the silver plating layer 14 using ion exchange water.

Next, the silver mirror post-treatment step of step S53 was carried out by spray coating a post-treatment solution in the form of 1 wt % 2-propanol onto the surface of the silver plating layer 14. Subsequently, the rinsing step of step S54 was carried out by spray cleaning the surface of the silver plating layer 14 using ion exchange water. Subsequently, the blow draining step of step S55 was carried out by blowing compressed air onto the surface of silver plating layer 14. Subsequently, the drying step of step S56 was carried out for 30 minutes in a drying oven at 70° C.

Finally, the top coating step of step S61 was carried out by spray coating an acrylic silicone-based top coating agent (“PTC-05”, Fujikura Kasei) onto the surface of the silver plating layer 14. Then, by carrying out the reaction step of step S62 for 60 minutes in a drying oven at 80° C., a top coat layer 15 having a uniform thickness of about 20 μm was formed on the surface of the silver plating layer 14. “PTC-05” is an acrylic silicone resin in which the Tg of the primary resin is 50° C., and contains an acrylic resin as the primary agent having an amine content of 18 wt %, and a curing agent in which the ratio of 3-glycidoxypropyltrimethoxysilane (GPMS) and tetraethoxysilane (TES) is 1:1 (blending ratio: primary agent:curing agent=100:20).

The resulting plated product 11 has a base coat layer 13, a silver plating layer 14, and a top coat layer 15 formed on the base layer 12. Crosslinking of the plated product 11 is allowed to proceed by aging by allowing the product to stand at normal temperature for 240 hours. Subsequently, the plated product 11 was used in an accelerated weather resistance test and moisture resistance test.

It should be noted that the Tg of the coating film of the top coat layer 15 in the plated product 11 prepared using “PTC-05” was 102° C.

<Accelerated Weather Resistance Test>

An accelerated weather resistance test was carried out for 10, 20, 30, and 40 cycles based on the following test conditions using the Model KU-R4 Diapla Metal Weather Super UV Tester manufactured by Suga Test Instruments.

Test Conditions:

Test cycle: Light irradiation (L) mode, 4 hours→Dark (R) mode, 4 hours→Dew condensation (D) mode, 4 hours L Mode:

UV irradiation conditions: wavelength 295 to 450 nm, intensity: 90 mW/cm, black panel temperature: 63° C., humidity: 70% RH

R Mode:

Black panel temperature: 63° C., humidity: 70% RH, water cooling of sample stand: OFF

D Mode:

Black panel temperature: 30° C., humidity: 100% RH, spraying conditions: 10 seconds before and after D mode, spraying water quality: pH 6 to 8, 105 Ωcm or more

<Moisture Resistance Test>

A moisture resistance test was carried out by immersing the plated product 11 in water at 40° C. for 240 hours, measuring Δb in the same manner as the accelerated weather resistance test, and measuring the adhesion between the top coat layer 15 and the silver plating layer 14, followed by evaluating the respective measurement results.

<Measurement of Δb>

The difference Δb, which is obtained by subtracting the b value before testing from the b value of the sample after accelerated weather resistance testing or moisture resistance testing, was used as an indicator of the degree of yellowing of the plated product 11 by focusing on b value, which indicates the yellow component of the Lab color specification system. In this case, the smaller the value of Δb, the lower the degree of yellowing, while the larger the value of Δb, the higher the degree of yellowing. It should be noted that b values were measured using a spectral calorimeter.

<Evaluation of Adhesion>

Adhesion between the top coat layer 15 and the silver plating layer 14 was evaluated by carrying out a taping test based on JIS G 0202 using cellophane tape, and assessing the manner of separation between the top coat layer 15 and the silver plating layer 14. It should be noted that the taping test refers to a method in which the base layer 12 is divided into the shape of a lattice, and a cellophane tape is affixed to each divided section, followed by investigating the manner of adhesion to the base layer 12 of the coating film after the tape is peeled off.

<Measurement of Coating Film Tg>

The Tg of the coating film was measured by the free oscillation method of a rigid pendulum using the Model RPT-3000W measuring instrument manufactured by A & D.

### EXAMPLE 2

A silver plated product 11 was prepared by changing the top coating agent in the Example 1 to “PTC-09” manufactured by Fujikura Kasei, after which it was used in an accelerated weather resistance test and moisture resistance test. “PTC-09” is an acrylic silicone resin in which the Tg of the primary resin is 90° C., and contains an acrylic resin as the primary agent having an amine content of 18 wt %, and a curing agent in which the ratio of GPMS and TES is 1:1 (blending ratio: primary agent:curing agent=100:20). The Tg of the coating film of the top coat layer 15 was 125° C. after aging the plated product 11 prepared using “PTC-09” for 240 hours at normal temperature.

### EXAMPLE 3

A silver plated product 11 was prepared by changing the top coating agent in the Example 1 to “PTC-0505” manufactured by Fujikura Kasei, after which it was used in an accelerated weather resistance test and moisture resistance test. “PTC-0505” is an acrylic silicone resin in which the Tg of the primary resin is 50° C., and contains an acrylic resin as the primary agent having an amine content of 9 wt %, and a curing agent in which the ratio of GPMS and TES is 1:1 (blending ratio: primary agent:curing agent=100:10). The Tg of the coating film of the top coat layer 15 was 85° C. after aging the plated product 11 prepared using “PTC-0505” for 240 hours at normal temperature.

### EXAMPLE 4

A silver plated product 11 was prepared by changing the top coating agent in the Example 1 to “PTC-05-B2” manufactured by Fujikura Kasei, after which it was used in an accelerated weather resistance test and moisture resistance test. “PTC-05-B2” is an acrylic silicone resin in which the Tg of the primary resin is 50° C., and contains an acrylic resin as the primary agent having an amine content of 18 wt %, and a curing agent in which the ratio of GPMS and TES is 1:0.75 (blending ratio: primary agent:curing agent=100:20). The Tg of the coating film of the top coat layer 15 was 104° C. after aging the plated product 11 prepared using “PTC-05-B2” for 240 hours at normal temperature.

### EXAMPLE 5

A silver plated product 11 was prepared by changing the top coating agent in the Example 1 to “PTC-05N” manufactured by Fujikura Kasei, after which it was used in an accelerated weather resistance test and moisture resistance test. “PTC-05N” is an acrylic silicone resin in which the Tg of the primary resin is 50° C., and contains an acrylic resin as the primary agent having an amine content of 18 wt %, and a curing agent in which the ratio of GPMS and TES is 1:1 (blending ratio: primary agent:curing agent=100:17.5). In addition, 15 wt % (solid ratio) of contraction relaxant in the form of acrylic polyol was added to the primary agent. Characteristics of acrylic polyol consist of an OH value of 15, molecular weight of 45000 and Tg of 32° C. The Tg of the coating film of the top coat layer 15 was 95° C. after aging the plated product 11 prepared using “PTC-05N” for 240 hours at normal temperature.

### EXAMPLE 6

A silver plated product 11 was prepared by changing the top coating agent in the Example 1 to “PTC-05N-B2” manufactured by Fujikura Kasei, after which it was used in an accelerated weather resistance test and moisture resistance test. “PTC-05N-B2” is an acrylic silicone resin in which the Tg of the primary resin is 50° C., and contains an acrylic resin as the primary agent having an amine content of 18 wt %, and a curing agent in which the ratio of GPMS and TES is 1:0.75 (blending ratio: primary agent:curing agent=100:17.5). In addition, 15 wt % of acrylic polyol was added to the primary agent. The Tg of the coating film of the top coat layer 15 was 102° C. after aging the plated product 11 prepared using “PTC-05N-B2” for 240 hours at normal temperature.

### EXAMPLE 7

A silver plated product 11 was prepared by changing the top coating agent in the Example 1 to “PTC-0505N-B2” manufactured by Fujikura Kasei, after which it was used in an accelerated weather resistance test and moisture resistance test. “PTC-0505N-B2” is an acrylic silicone resin in which the Tg of the primary resin is 50° C., and contains an acrylic resin as the primary agent having an amine content of 18 wt %, and a curing agent in which the ratio of GPMS and TES is 1:0.75 (blending ratio: primary agent:curing agent=100:8.75). In addition, 15 wt % of acrylic polyol was added to the primary agent. The Tg of the coating film of the top coat layer 15 was 82° C. after aging the plated product 11 prepared using “PTC-0505N-B2” for 240 hours at normal temperature.

### EXAMPLE 8

A silver plated product 11 was prepared by changing the top coating agent in the Example 1 to “PTC-05N-UH10b-B2” manufactured by Fujikura Kasei, after which it was used in an accelerated weather resistance test and moisture resistance test. “PTC-05N-UH10b-B2” is an acrylic silicone resin in which the Tg of the primary resin is 50° C., and contains an acrylic resin as the primary agent having an amine content of 18 wt %, and a curing agent in which the ratio of GPMS and TES is 1:0.75 (blending ratio: primary agent:curing agent=100:17.5). In addition, 15 wt % of the acrylic polyol, 3.8 wt % of anilide oxalate-based ultraviolet absorber not having a hydroxyl group in its molecule, and 0.48 wt % of HALS having one hydroxyl group in its molecule were added to the primary agent of “PTC-05N-UH10b-B2”. The Tg of the coating film of the top coat layer 15 was 72° C. after aging the plated product 11 prepared using “PTC-05N-UH10b-B2” for 240 hours at normal temperature.

### EXAMPLE 9

A silver plated product 11 was prepared by changing the top coating agent in the Example 1 to “PTC-05N-UH5bA-B2” manufactured by Fujikura Kasei, after which it was used in an accelerated weather resistance test and moisture resistance test. In “PTC-05N-UH5bA-B2”, the added amount of anilide oxalate-based ultraviolet absorber in “PTC-05N-UH10b-B2” in the Example 8 was reduced to 1.9 wt %. The Tg of the coating film of the top coat layer 15 was 81° C. after aging the plated product 11 prepared using “PTC-05N-UH5bA-B2” for 240 hours at normal temperature.

### EXAMPLE 10

A silver plated product 11 was prepared by changing the top coating agent in the Example 1 to “PTC-05N-UH5bC-B2” manufactured by Fujikura Kasei, after which it was used in an accelerated weather resistance test and moisture resistance test. In “PTC-05N-UH5bC-B2”, the HALS in “PTC-05N-UH5bA-B2” of the Example 9 was changed to that not having a hydroxyl group in its molecule. The Tg of the coating film of the top coat layer 15 was 80° C. after aging the plated product 11 prepared using “PTC-05N-UH5bC-B2” for 240 hours at normal temperature.

### EXAMPLE 11

A silver plated product 11 was prepared by changing the top coating agent in the Example 1 to “T40-a0.7h” manufactured by Origin Electric, after which it was used in an accelerated weather resistance test and moisture resistance test. “T40-a0.7h” is an acrylic silicone resin in which the Tg of the primary resin is 40° C., and contains an acrylic resin as the primary agent having an amine content of 10 wt %, and a curing agent in which the ratio of GPMS and TES is 1:0.5 (blending ratio: primary agent:curing agent=100:25). In addition, a benzotriazole-based ultraviolet absorber at 0.7 wt % and HALS at 0.3 wt % were added to the primary agent. The Tg of the coating film of the top coat layer 15 was 80° C. after aging the plated product 11 prepared using “T40-a0.7h” for 240 hours at normal temperature.

### EXAMPLE 12

A silver plated product 11 was prepared by changing the top coating agent in the Example 1 to “T50-a0.7h” manufactured by Origin Electric, after which it was used in an accelerated weather resistance test and moisture resistance test. “T50-a0.7h” is an acrylic silicone resin in which the Tg of the primary resin is 50° C., and contains an acrylic resin as the primary agent having an amine content of 10 wt %, and a curing agent in which the ratio of GPMS and TES is 1:0.5 (blending ratio: primary agent:curing agent=100:25). In addition, a benzotriazole-based ultraviolet absorber at 0.7 wt % and HALS at 0.3 wt % were added to the primary agent. The Tg of the coating film of the top coat layer 15 was 91° C. after aging the plated product 11 prepared using “T50-a0.7h” for 240 hours at normal temperature.

### EXAMPLE 13

A silver plated product 11 was prepared by changing the top coating agent in the Example 1 to “T40-b1.0h” manufactured by Origin Electric, after which it was used in an accelerated weather resistance test and moisture resistance test. “T40-b1.0h” is an acrylic silicone resin in which the Tg of the primary resin is 40° C., and contains an acrylic resin as the primary agent having an amine content of 10 wt %, and a curing agent in which the ratio of GPMS and TES is 1:0.5 (blending ratio: primary agent:curing agent=100:25). In addition, a triazine-based ultraviolet absorber at 1.0 wt % and HALS at 0.3 wt % were added to the primary agent. The Tg of the coating film of the top coat layer 15 was 78° C. after aging the plated product 11 prepared using “T40-b1.0h” for 240 hours at normal temperature.

### EXAMPLE 14

A silver plated product 11 was prepared by changing the top coating agent in the Example 1 to “T40-b1.5h” manufactured by Origin Electric, after which it was used in an accelerated weather resistance test and moisture resistance test. “T40-b1.5h” is an acrylic silicone resin in which the Tg of the primary resin is 40° C., and contains an acrylic resin as the primary agent having an amine content of 10 wt %, and a curing agent in which the ratio of GPMS and TES is 1:0.5 (blending ratio: primary agent:curing agent=100:25). In addition, a triazine-based ultraviolet absorber at 1.5 wt % and HALS at 0.3 wt % were added to the primary agent. The Tg of the coating film of the top coat layer 15 was 77° C. after aging the plated product 11 prepared using “T40-b1.5h” for 240 hours at normal temperature.

### EXAMPLE 15

A silver plated product 11 was prepared by changing the top coating agent in the Example 1 to “T40-b1.5” manufactured by Origin Electric, after which it was used in an accelerated weather resistance test and moisture resistance test. “T40-b1.5” is an acrylic silicone resin in which the Tg of the primary resin is 40° C., and contains an acrylic resin as the primary agent having an amine content of 10 wt %, and a curing agent in which the ratio of GPMS and TES is 1:0.5 (blending ratio: primary agent:curing agent=100:25). In addition, a triazine-based ultraviolet absorber at 1.5 wt % was added to the primary agent. The Tg of the coating film of the top coat layer 15 was 74° C. after aging the plated product 11 prepared using “T40-b1.5” for 240 hours at normal temperature.

### EXAMPLE 16

A silver plated product 11 was prepared by changing the post-treatment solution after formation of the silver plating layer in the Example 15 to an aqueous solution of 1% by weight of sodium hydrogensulfite, after which it was used in an accelerated weather resistance test and moisture resistance test. The Tg of the coating film of the top coat layer 15 was 74° C. after aging the plated product 11 for 240 hours at normal temperature.

### EXAMPLE 17

The silver mirror pretreatment step of step S41 in the Example 16 was carried out using tin[II] chloride solution containing 2 wt % tin[II] chloride, 1 wt % hydrochloric acid and 2 wt % D-glucose. Moreover, an ammoniacal silver nitrate solution prepared by dropping 28 wt % aqueous ammonia into 0.5 wt % silver nitrate solution until the silver oxide brown precipitate disappeared, and a reducing agent solution composed of a 0.05 wt % aqueous solution of hydrazine hydrate, were used in the silver mirror coating step of step S51. Furthermore, ion exchange water was used to prepare the aqueous silver nitrate solution. In addition, the amount of 28 wt % aqueous ammonia used to prepare the ammoniacal silver nitrate solution was an amount equivalent to 0.5 wt %. The silver plated product 11 prepared in this manner was then used in an accelerated weather resistance test and moisture resistance test. The Tg of the coating film of the top coat layer 15 was 74° C. after aging this plated product 11 prepared in this manner for 240 hours at normal temperature.

### COMPARATIVE EXAMPLE 1

A silver plated product 11 was prepared by changing the top coating agent in the Example 1 to “PTC-02” manufactured by Fujikura Kasei, after which it was used in an accelerated weather resistance test and moisture resistance test. “PTC-02” is an acrylic silicone resin in which the Tg of the primary resin is 30° C., and contains an acrylic resin as the primary agent having an amine content of 18 wt %, and a curing agent in which the ratio of GPMS and TES is 1:1 (blending ratio: primary agent:curing agent=100:20). In addition, 15 wt % of acrylic polyole was added to the primary agent. The Tg of the coating film of the top coat layer 15 was 68° C. after aging the plated product 11 prepared using “PTC-02” for 240 hours at normal temperature.

### COMPARATIVE EXAMPLE 2

A silver plated product 11 was prepared by changing the top coating agent in the Example 1 to “PTC-02UH(10d)” manufactured by Fujikura Kasei, after which it was used in an accelerated weather resistance test and moisture resistance test. “PTC-02UH(10d)” consists of adding 3.8 wt % benzotriazole-based ultraviolet absorber having a hydroxyl group in its molecule and 0.48 wt % HALS having a hydroxyl group in its molecule to the primary agent of “PTC-02” of Comparative Example 1. The Tg of the coating film of the top coat layer 15 was 57° C. after aging the plated product 11 prepared using “PTC-02UH(10d)” for 240 hours at normal temperature.

### COMPARATIVE EXAMPLE 3

A silver plated product 11 was prepared by changing the top coating agent in the Example 1 to “PTC-02UH(10b)” manufactured by Fujikura Kasei, after which it was used in an accelerated weather resistance test and moisture resistance test. “PTC-02UH(10b)” consists of adding 3.8 wt % anilide oxalate-based ultraviolet absorber and 0.48 wt % HALS having a hydroxyl group in its molecule to the primary agent of “PTC-02” of Comparative Example 1. The Tg of the coating film of the top coat layer 15 was 58° C. after aging the plated product 11 prepared using “PTC-02UH(10b)” for 240 hours at normal temperature.

### COMPARATIVE EXAMPLE 4

A silver plated product 11 was prepared by changing the top coating agent in the Example 1 to “Origizug #100” manufactured by Origin Electric, after which it was used in an accelerated weather resistance test and moisture resistance test. “Origizug #100” is an acrylic silicone resin in which the Tg of the primary resin is 30° C., and contains an acrylic resin as the primary agent having an amine content of 10 wt %, and a curing agent in which the ratio of GPMS and TES is 1:0.5 (blending ratio: primary agent:curing agent=100:25). In addition, a benzotriazole-based ultraviolet absorber at 0.7 wt % and HALS at 0.3 wt % were added to the primary agent. The Tg of the coating film of the top coat layer 15 was 57° C. after aging plated product 11 prepared using “Origizug #100” for 240 hours at normal temperature.

Next, the evaluation results following moisture resistance testing on each of the samples of Examples 1 to 17 and Comparative Examples 1 to 4 are explained with reference to Table 1 through Table 4.

TABLE 1

| | | | Comp. | | | | | | | |
|---|---|---|---|---|---|---|---|---|---|---|
| | | | example 1 | Example 1 | Example 2 | Example 3 | Example 4 | Example 5 | Example 6 | Example 7 |
| Acrylic silicone coating | | | PTC-02 | PTC-05 | PTC-09 | PTC-0505 | PTC-05-B2 | PTC-05N | PTC-05N-B2 | PTC-0505N-B2 |
| Primary | Primary | Tg | 30 | 50 | 90 | 50 | 50 | 50 | 50 | 50 |
| agent | resin | (° C.) | | | | | | | | |
| | | Amine | 18 | 18 | 18 | 9 | 18 | 18 | 18 | 9 |
| | | content | | | | | | | | |
| | | (%) | | | | | | | | |
| | Additive | Contrac- | — | — | — | — | — | 15 | 15 | 15 |
| | | tion | | | | | | | | |
| | | relaxant | | | | | | | | |
| | | (%) | | | | | | | | |
| Curing | GPMS: | 1:1 | 1:1 | 1:1 | 1:1 | 1:0.75 | 1:1 | 1:0.75 | 1:0.75 | |
| agent | TES | | | | | | | | | |
| Coating | Tg (° C.) | | 68 | 102 | 125 | 85 | 104 | 95 | 102 | 82 |
| film | | | | | | | | | | |

| | | | | | | | | | | | | | | | | | |
|---|---|---|---|---|---|---|---|---|---|---|---|---|---|---|---|---|---|
| | | | Ad- | | Ad- | | Ad- | | Ad- | | Ad- | | | | | | |
| | | | he- | | he- | | he- | | he- | | he- | | Ad- | | Ad- | | |
| | | Δb | sion | Δb | sion | Δb | sion | Δb | sion | Δb | sion | Δb | hesion | Δb | hesion | Δb | Adhesion |
| Super | 10 cycles | 5.4 | ∘ | 4.0 | ∘ | 3.3 | Δ | 2.8 | ∘ | −0.2 | x | 3.9 | ∘ | 0.0 | ∘ | 0.3 | ∘ |
| UV | | | | | | | | | | | | | | | | | |
| | 20 cycles | 10.3 | x | 11.6 | x | 1.5 | x | 3.6 | Δ | 1.9 | x | 8.8 | Δ | 1.5 | Δ | 0.9 | ∘ |
| | 30 cycles | 14.1 | x | | | | | 3.9 | Δ | 2.2 | x | 9.2 | x | 1.7 | Δ | 1.5 | ∘ |
| | 40 cycles | 15.7 | x | | | | | | | 2.9 | x | | | 1.5 | x | 1.6 | ∘ |

| | | | | | | | | | | | | | | | | |
|---|---|---|---|---|---|---|---|---|---|---|---|---|---|---|---|---|
| Moisture resistance test | 4.7 | ∘ | 3.6 | x | −1.6 | x | −0.6 | ∘ | 2.5 | x | 2.7 | ∘ | 0.3 | ∘ | 0.1 | ο |

TABLE 2

| | | | Comparative | Comparative | | | |
|---|---|---|---|---|---|---|---|
| | | | Example 2 | Example 3 | Example 8 | Example 9 | Example 10 |
| Acrylic silicone coating | | | PTC-02UH(10d) | PTC-02UH(10b) | PTC-10b-B2 | PTC-05N- | PTC-05N-UH5bC- |
| | | | | | | UH5bA-B2 | B2 |
| Primary agent | Primary resin | Tg(° C.) | 30 | 30 | 50 | 50 | 50 |
| | | Amine content | 18 | 18 | 18 | 18 | 18 |
| | | (%) | | | | | |
| | Additive | Contraction | — | — | 15 | 15 | 15 |
| | | relaxant | | | | | |
| | | (%) | | | | | |
| | | UVa(%) | BTA 3.8 | OA 3.8 | OA 3.8 | OA 1.9 | OA 1.9 |
| | | HALS(%) | OH+ 0.48 | OH+ 0.48 | OH+ 0.48 | OH+ 0.48 | OH− 0.48 |
| Curing agent | GPMS:TES | 1:1 | 1:1 | 1:0.75 | 1:0.75 | 1:0.75 | |
| Coating film | Tg(° C.) | | 57 | 58 | 72 | 81 | 80 |

| | | | | | | | | | | | |
|---|---|---|---|---|---|---|---|---|---|---|---|
| | | | | | | | Ad- | | | | |
| | | | | | | | he- | | Ad- | | |
| | | Δb | Adhesion | Δb | Adhesion | Δb | sion | Δb | hesion | Δb | Adhesion |
| Super UV | 10 cycles | 9.2 | ∘ | 6.1 | ∘ | 1.6 | ∘ | 0.9 | Δ | 0.7 | ∘ |
| | 20 cycles | 7.2 | ∘ | 8.2 | ∘ | 2.7 | ∘ | 1.6 | Δ | 1.6 | ∘ |
| | 30 cycles | 12.4 | Δ | 7.9 | ∘ | 3.9 | ∘ | 2.6 | Δ | 1.9 | ∘ |
| | 40 cycles | 16.6 | x | 8.1 | Δ | 4.2 | ∘ | 3.8 | x | 2.4 | ∘ |

| | | | | | | | | | | |
|---|---|---|---|---|---|---|---|---|---|---|
| Moisture resistance test | 3.5 | ∘ | 1.1 | ∘ | −0.5 | ∘ | 0.8 | ∘ | −0.2 | ο |

Uva:
OA: Anilide oxalate based
BTA: Benzotriazole based

TABLE 3

| | | | Comparative | | | | | |
|---|---|---|---|---|---|---|---|---|
| | | | Example 4 | Example 11 | Example 12 | Example 13 | Example 14 | Example 15 |
| Acrylic silicone coating | | | #100 | T40-a0.7h | T50-a0.7h | T40-b1.0h | T40-b1.5h | T40-b1.5 |
| Primary | Primary | Tg(° C.) | 30 | 40 | 50 | 40 | 40 | 40 |
| agent | resin | Amine | 10 | 10 | 10 | 10 | 10 | 10 |
| | | content (%) | | | | | | |
| | Additive | UVa (%) | BTA 0.7 | BTA 0.7 | BTA 0.7 | TA 1.0 | TA 1.5 | TA 1.5 |
| | | HALS (%) | OH+ 0.3 | OH+ 0.3 | OH+ 0.3 | OH+ 0.3 | OH+ 0.3 | — |
| Curing | GPMS:TES | | 1:0.5 | 1:0.5 | 1:05 | 1:0.5 | 1:0.5 | 1:0.5 |
| agent | | | | | | | | |
| Coating | Tg(° C.) | | 57 | 80 | 91 | 78 | 77 | 74 |
| film | | | | | | | | |

| | | | | | | | | | | | | | |
|---|---|---|---|---|---|---|---|---|---|---|---|---|---|
| | | Δb | Adhesion | Δb | Adhesion | Δb | Adhesion | Δb | Adhesion | Δb | Adhesion | Δb | Adhesion |
| Super UV | 10 cycles | 6.3 | ∘ | 3.9 | ∘ | 3.5 | Δ | 2.0 | ∘ | 1.3 | ∘ | 0.3 | ∘ |
| | 20 cycles | 11.1 | ∘ | 6.0 | ∘ | 6.3 | Δ | 4.1 | ∘ | 4.2 | ∘ | 2.5 | x |
| | 30 cycles | 20.3 | x | | | | | 9.5 | Δ | 9.5 | ∘ | 5.5 | x |
| | 40 cycles | 25.4 | x | | | | | | | 14.8 | Δ | 11.3 | x |

| | | | | | | | | | | | | |
|---|---|---|---|---|---|---|---|---|---|---|---|---|
| Moisture resistance test | 4.7 | ∘ | 3.2 | ∘ | 0.8 | Δ | 2.5 | ∘ | 1.3 | ∘ | 0.4 | ο |

Uva:
BTA: Benzotriazole based
TA: Triazine based

TABLE 4

| | | Comp. | | | | | | | |
|---|---|---|---|---|---|---|---|---|---|
| | | example 4 | | Example 15 | | Example 16 | | Example 17 | |
| First pretreatment liquid | Tin [II] chloride (%) | 3 | | 3 | | 3 | | 2 | |
| | Hydrochloric acid (%) | 1 | | 1 | | 1 | | 1 | |
| | D-glucose (%) | — | | — | | — | | 2 | |
| Silver mirror coating step | Silver nitrate solution | Daitec LA | | Daitec LA | | Daitec LA | | Silver nitrate 0.5% | |
| | | | | | | | | 28% aqueous | |
| | | | | | | | | ammonia(*) | |
| | Reducing agent solution | Daitec LB | | Daitec LB | | Daitec LB | | Hydrazine hydrate | |
| | | | | | | | | 0.05% | |
| Post-treatment liquid | 2-propanol (%) | 1 | | 1 | | — | | — | |
| | Sodium hydrogen sulfite (%) | — | | — | | 1 | | 1 | |
| Acrylic silicone coating | | #100 | | T40-b1.5 | | T40-b1.5 | | T40-b1.5 | |
| Primary agent | Primary resin Tg(° C.) | 30 | | 40 | | 40 | | 40 | |
| | Amine content (%) | 10 | | 10 | | 10 | | 10 | |
| | Additive UVa(%) | BTA 0.7 | | TA 1.5 | | TA 1.5 | | TA 1.5 | |
| | HALS(%) | OH+ 0.3 | | — | | — | | — | |
| Curing agent | GPMS:TES | 1:0.5 | | 1:0.5 | | 1:0.5 | | 1:0.5 | |
| Coating film | Tg(° C.) | 57 | | 74 | | 74 | | 74 | |
| | | Δb | Adhesion | Δb | Adhesion | Δb | Adhesion | Δb | Adhesion |
| Super UV | 10 cycles | 6.3 | ∘ | 0.3 | ∘ | 0.3 | ∘ | 0.3 | ∘ |
| | 20 cycles | 11.1 | ∘ | 2.5 | x | 2.1 | ∘ | 1.4 | ∘ |
| | 30 cycles | 20.3 | x | 5.5 | x | 2.8 | ∘ | 2.2 | ∘ |
| | 40 cycles | 25.4 | x | 11.3 | x | 3.5 | ∘ | 2.7 | ∘ |

| | | | | | | | | |
|---|---|---|---|---|---|---|---|---|
| Moisture resistance test | 4.7 | ∘ | 0.4 | ∘ | 0.3 | ∘ | 0.3 | ο |

Uva:
BTA: Benzotriazole based
TA: Triazine based
(*)Dropped in until brown precipitate disappeared, and the amount dropped in was about 0.5%

As is shown in Table 1, in Comparative Example 1, which serves as the blank data of Examples 1 through 7, the Tg after aging the acrylic silicone resin coating film formed as the top coat layer 15 was 68° C. According to the results of the accelerated weather resistance test, the value of Δb, which represents the degree of yellowing of plated product 11 when light irradiation was repeated using the Super UV tester, was 5.4 after 10 cycles, 10.3 after 20 cycles, 14.1 after 30 cycles and 15.7 after 40 cycles. Namely, the value of Δb became larger as the number of cycles increased, signifying an increase in the degree of yellowing in terms of the appearance of the plated product 11. In addition, in an evaluation of the adhesion between the top coat layer 15 and the silver plating layer 14 at 10 cycles as determined by the taping test, none of the 36 divided sections peeled off even when the taping test was repeated 10 times, thereby indicating satisfactory adhesion. After 20 cycles, however, adhesion decreased as all of the sections ended up peeling off the first time the taping test was performed.

On the other hand, as a result of immersing for 240 hours in hot water at 40° C. in the form of a moisture resistance test, the appearance of the plated product 11 yellowed, and the value of Δb was 4.7. In addition, in an evaluation of the adhesion between the top coat layer 15 and the silver plating layer 14, none of the 100 divided sections peeled off even when the taping test was repeated 10 times, thus indicating that satisfactory adhesion was maintained.

In Example 1, Tg of the primary resin of the primary agent, namely the acrylic resin, was 20° C. higher than in Comparative Example 1. As a result, the Tg following aging of the acrylic silicone resin coating film formed as the top coat layer 15 rose from 68° C. to 102° C. According to the results of an accelerated weather resistance test in which light irradiation was repeated for 10 cycles using a Super UV Tester, the value of Δb decreased from 5.4 to 4.0. In this manner, an inhibitory effect on yellowing was observed in Example 1 as compared with Comparative Example 1. In addition, in the evaluation of the adhesion between the top coat layer 15 and the silver plating layer 14 according to the taping test, satisfactory adhesion was demonstrated since none of the 36 divided sections were peeled off even when the taping test was repeated 10 times.

On the other hand, according to the results of the moisture resistance test, the value of Δb decreased from 4.7 to 3.6 in Comparative Example 1, and an inhibitory effect on yellowing was observed. However, in the evaluation of adhesion between the top coat layer 15 and the silver plating layer 14, nearly all of the divided sections ended up peeling off the first time the taping test was performed. This suggested that there is room for improvement of adhesion in the case of, for example, applying this plated product 11 to a location that frequently comes in direct contact with water.

The Tg of the acrylic resin of Example 2 was 40° C. higher than the Tg of the acrylic resin of Example 1. As a result, the Tg of the acrylic silicone resin coating film rose even further to 125° C. In the accelerated weather resistance test, further improvement of yellowing inhibitory effect was observed, with Δb exhibiting a value of 3.3 following 10 cycles of repeated light irradiation, and a value of 1.5 following 20 cycles of repeated light irradiation. On the other hand, some of the divided sections peeled off during the first round of taping testing following 10 cycles of light irradiation. On the basis of these results, there is recognized to be room for improvement of adhesion in the case of, for example, applying plated product 11 to a location exposed to intense ultraviolet rays.

According to the results of the moisture resistance test as well, yellowing was greatly inhibited, with Δb demonstrating a value of −1.6. However, in the taping test, nearly all of the divided sections peeled off after one round of testing, and it was recognized that there is still room for improvement of adhesion.

The amount of amine in the acrylic resin of Example 3 was 9 wt %, which is half of the amount of 18 wt % of Example 1, and the number of betaine structures in the acrylic silicone resin coating film was reduced by half. In this example, although the Tg of the acrylic silicone resin coating film is 85° C., the value of Δb was 2.8 after 10 cycles of light irradiation using a Super UV Tester, 3.6 after 20 cycles of light irradiation and 3.9 after 30 cycles of light irradiation, and a considerable improvement in weather resistance was observed. In addition, as a result of evaluating adhesion between the top coat layer 15 and the silver plating layer 14 following light irradiation, none of the divided sections were observed to peel off even after repeating 10 cycles of light irradiation and repeating the taping test 10 times. In addition, only a portion of the divided sections peeled off in the first round of the taping test when 20 cycles of light irradiation were repeated.

In the results of the moisture resistance test as well, the value of Δb was −0.6, and none of the divided sections were observed to peel off even after the taping test was repeated ten times, thus demonstrating a considerable improvement in the inhibitory effect on yellowing as well as a high degree of adhesion.

In Example 4, a curing agent was used in which the blending ratio of TES relative to GMPS was lower in comparison with that of Example 1. As a result, the mesh structures formed three-dimensionally by siloxane bonds between the acrylic primary chains were denser, and the moisture resistance of the top coat layer 15 was improved. The Tg after aging of the acrylic silicone resin coating film was 104° C. In this example, the value of Δb was −0.2 after 10 cycles of light irradiation using a Super UV Tester, 1.9 after 20 cycles of light irradiation, 2.2 after 30 cycles of light irradiation, and 2.9 after 40 cycles of light irradiation, and a considerable improvement in weather resistance was observed. In addition, according to the results of the moisture resistance test as well, a significant improvement in moisture resistance was observed, with Δb exhibiting a value of 2.5.

However, in the present example, nearly all of the divided sections ended up peeling off in a single round of the taping test under all conditions of the accelerated weather resistance test and moisture resistance test, and room for improvement was observed with respect to adhesion between the top coat layer 15 and the silver plating layer 14.

In Example 5, a contraction relaxant was added at 6 wt % to the primary agent in which the acrylic resin of the composition of Example 1 was used for the primary resin. The Tg following aging of the acrylic silicone resin coating film was 95° C. In the present example, the value of Δb was 3.9 after 10 cycles of light irradiation using the Super UV Tester, 8.8 after 20 cycles of light irradiation, and 9.2 after 30 cycles of light irradiation, and an improvement in weather resistance was observed. In addition, as a result of evaluating adhesion between the top coat layer 15 and the silver plating layer 14 following light-irradiation, none of the divided sections were observed to peel off after 10 cycles of light irradiation even when the taping test was repeated 10 times. In addition, only a portion of the divided sections peeled off after one round of the taping test even when light irradiation was repeated for 20 cycles.

In addition, in the results of the moisture resistance test as well, the value of Δb was 2.7, and none of the divided sections were observed to peel off even when the taping test was repeated 10 times, thus demonstrating both improved yellowing inhibitory effect and a high degree of adhesion.

In Example 6, together with adding a contraction relaxant at 6 wt % to the primary agent in which the acrylic resin of the composition of Example 1 was used as the primary resin, a curing agent was used in which the blending ratio of TES relative to GPMS is lower than that of Example 5. For this reason, the mesh structures formed three-dimensionally by siloxane bonds between the acrylic primary chains were denser, and thus the moisture resistance of the top coat layer 15 was improved. The Tg following aging of the acrylic silicone resin coating film was 102° C. In the present example, the value of Δb was 0.0 after 10 cycles of light irradiation using the Super UV Tester, 1.5 after 20 cycles of light irradiation, 1.7 after 30 cycles of light irradiation and 1.5 after 40 cycles of light irradiation, and a considerable improvement in weather resistance was observed. In addition, as a result of evaluating adhesion between the top coat layer 15 and the silver plating layer 14 following light irradiation, none of the divided sections peeled off after repeating 10 cycles of light irradiation even when the taping test was repeated ten times. In addition, only a portion of the divided sections peeled off after the first round of the taping test even after light irradiation was repeated for 20 cycles and 30 cycles.

In addition, in the results of the moisture resistance test as well, the value of Δb was 0.3 and none of the divided sections were observed to peel off even when the taping test was repeated ten times, thus exhibiting a significant improvement in yellowing inhibitory effect as well as a high degree of adhesion.

In Example 7, the amine content of the acrylic resin was reduced half to 9 wt % as compared with the 18 wt % in Example 6, and the number of betaine structures in the acrylic silicone resin coating film was correspondingly reduced by half based on the constitution of Example 6. In addition, a curing agent having a smaller blending ratio of TES relative to GPMS was used in the acrylic silicone resin in the same manner as the Example 6. For this reason, the mesh structure formed three-dimensionally by siloxane bonds between the acrylic primary chains was denser, the moisture resistance of the top coat layer 15 was improved. The Tg following aging of the acrylic silicone resin coating film was 82° C.

In Example 7, the value of Δb was 0.3 after 10 cycles of light irradiation for 10 cycles using the Super UV Tester, 0.9 after 20 cycles of light irradiation, 1.5 after 30 cycles of light irradiation, and 1.8 after 40 cycles of light irradiation, and a considerable improvement in weather resistance was observed. In addition, as a result of evaluating adhesion between the top coat layer 15 and the silver plating layer 14 after light irradiation, none of the divided sections were observed to peel off after 40 cycles of light irradiation even when the taping test was repeated 10 times.

In addition, in the results of the moisture resistance test as well, the value of Δb was 0.1, and none of the divided sections were observed to peel off even when the taping test was repeated 10 times, thus demonstrating a significant improvement in the inhibitory effect on yellowing as well as a high degree of adhesion.

Next, as shown in Table 2, in Comparative Example 2, which served as a blank for Examples 8 through 10, the acrylic silicone resin formed as the top coat layer 15 differed from acrylic silicone resin of the Comparative Example 1, and the Tg following aging of its coating film was 57° C. In the results of the accelerated weather resistance test, the value of Δb when light irradiation was repeated using the Super UV Tester was 9.2 after 10 cycles, 7.2 after 20 cycles, 12.4 after 30 cycles, and 16.6 after 40 cycles. In Comparative Example 2, a benzotriazole-based ultraviolet absorber, having a single hydroxyl group in its molecule, and HALS were added to the acrylic silicone coating. However, even though the ultraviolet absorber and HALS were simply added for the purpose of improving weather resistance, yellowing of the plated product 11 during the accelerated weather resistance test was unable to be inhibited.

In addition, in an evaluation of the adhesion between top coat layer 15 and the silver plating layer 14 by a taping test, satisfactory adhesion was demonstrated up to 20 cycles of light irradiation even when the taping test was repeated 10 times, with none of the 36 divided sections peeling off. However, some of the divided sections peeled off during the first round of the taping test after 30 cycles of light irradiation, and when subjected to 40 cycles of light irradiation, adhesion decreased to the extent that all of the divided sections peeled off in a single round of the taping test.

As a result of immersing in hot water at 40° C. for 240 hours in the moisture resistance test, the appearance of plated product 11 was slightly yellowed, and the value of Δb was 3.5. In addition, when adhesion between the top coat layer 15 and the silver plating layer 14 was evaluated, satisfactory adhesion was maintained, with none of the 100 divided sections peeling off even when the taping test was repeated 10 times.

In Comparative Example 3, which also served as a blank for Examples 8 through 10, the acrylic silicone resin formed as the top coat layer 15 differed from the acrylic silicone resin of the Comparative Example 1, and the Tg after aging of its coating was 58° C. In the results of the accelerated weather resistance test, the value of Δb when light irradiation was repeated using the Super UV Tester was 6.1 after 10 cycles, 8.2 after 20 cycles, 7.9 after 30 cycles, and 8.1 after 40 cycles. In Comparative Example 3, an anilide oxalate-based ultraviolet absorber not having any hydroxyl groups in its molecule and HALS having a hydroxyl group in its molecule were added to the acrylic silicone coating. As a result of eliminating the hydroxyl group from ultraviolet absorber in this manner, although the rate of yellowing of the plated product 11 decreased as the number of cycles increased in comparison with the Comparative Example 1, since the Tg of the coating film was only about 58° C., it did not reach a level at which its yellowing inhibitor effect could be said to be adequate.

In an evaluation of the adhesion between the top coat layer 15 and the silver plating layer 14 as determined by a taping test, satisfactory adhesion was demonstrated since none of the 36 divided sections peeled off after 30 cycles of light irradiation even when the taping test was repeated 10 times. However, in the case of 40 cycles of light irradiation, adhesion decreased since some of the divided sections peeled off after one round of the taping test.

As a result of immersing in hot water at 40° C. for 240 hours in a moisture resistance test, yellowing of the appearance of the plated product 11 was inhibited, and the value of Δb was 1.1. In addition, in an evaluation of the adhesion between the top coat layer 15 and the silver plating layer 14, satisfactory adhesion was demonstrated, with none of the 100 divided sections peeling off even when the taping test was repeated 10 times.

In Example 8, together with adding a contraction relaxant at 6 wt % to the primary agent in which the acrylic resin of the composition of Example 1 was used as the primary resin, a curing agent was used in which the blending ratio of TES relative to GPMS was lower than that in Example 1. In addition, an anilide oxalate-based ultraviolet absorber not having a hydroxyl group in its molecule at 3.8 wt % and HALS having a hydroxyl group in its molecule at 0.48 wt % were added to this primary agent. The Tg after aging of the acrylic silicone resin coating film in Example 8 was 72° C. In the present example, the value of Δb was 1.6 after 10 cycles of light irradiation using the Super UV Tester, 2.7 after 20 cycles of light irradiation, 3.9 after 30 cycles of light irradiation, and 4.2 after 40 cycles of light irradiation, and a considerable improvement in weather resistance was observed. In addition, as a result of evaluating adhesion between the top coat layer 15 and the silver plating layer 14 after light irradiation, none of the divided sections were observed to peel off after 40 cycles of light irradiation even when the taping test was repeated 10 times.

Further, in the results of the moisture resistance test as well, the value of Δb was −0.5 and none of the divided sections were observed to peel off even when the taping test was repeated 10 times, thereby demonstrating a considerable improvement in yellowing inhibitory effect while also exhibiting a high degree of adhesion.

The acrylic silicone resin of Example 8 is equivalent to a composition in which an anilide oxalate-based ultraviolet absorber and HALS are added to the acrylic silicone resin of the Example 6. When Example 6 and Example 8 are compared, in contrast to the composition of Example 6 being superior with respect to yellowing inhibitory effect in the accelerated weather resistance test, the composition of Example 8 realized a high degree of adhesion between the top coat layer 15 and the silver plating layer 14 while ensuring that the yellowing inhibitory effect was within the required level.

In Example 9, the amount of anilide oxalate-based ultraviolet absorber of the primary agent used in Example 8 was reduced by half and adjusted to 1.9 wt %. The Tg after aging of the acrylic silicone resin coating film in Example 9 was 81° C. In the present example, the value of Δb was 0.9 after 10 cycles of light irradiation using the Super UV Tester, 1.6 after 20 cycles of light irradiation, 2.6 after 30 cycles of light irradiation, and 3.8 after 40 cycles of light irradiation, and a considerable improvement in weather resistance was observed. In addition, as a result of evaluating adhesion between the top coat layer 15 and the silver plating layer 14 after irradiating with light, a portion of the divided sections were observed to peel off after a single round of the taping test both after 10 cycles and 20 cycles of light irradiation.

On the other hand, in the results of the moisture resistance test, the value of Δb was 0.8 and none of the divided sections were observed to peel off even when the taping test was repeated 10 times, thereby exhibiting a considerable improvement in yellowing inhibitory effect as well as a high degree of adhesion.

In Example 10, the HALS of the primary agent was changed from that having a hydroxyl group in its molecule as in the composition of Example 9 to that not having a hydroxyl group in its molecule. The Tg after aging of the acrylic silicone resin coating film in the present example was 80° C. In the present example, the value of Δb was 0.7 after 10 cycles of light irradiation using the Super UV Tester, 1.6 after 20 cycles of light irradiation, 1.9 after 30 cycles of light irradiation, and 2.4 after 40 cycles of light irradiation, and a considerable improvement in weather resistance was observed. In addition, as a result of evaluating adhesion between the top coat layer 15 and the silver plating layer 14 after irradiating with light, none of the divided sections were observed to peel off after 40 cycles of light irradiation even when the taping test was repeated 10 times.

Further, in the results of the moisture resistance test as well, the value of Δb was −0.2, and none of the divided sections were observed to peel off even when the taping test was repeated 10 times, thereby demonstrating a considerable improvement in yellowing inhibitory effect as well as a high degree of adhesion.

In this manner, by making the HALS added to the acrylic silicone resin that which does not have a hydroxyl group in its molecule, the plated product 11 was able to demonstrate superior inhibition of yellowing and inhibition of peeling under the conditions of the accelerated weather resistance test and moisture resistance test even if the added amount of ultraviolet absorber was reduced.

Next, as shown in Table 3, in Comparative Example 4, which served as a blank for Examples 11 through 15, the acrylic silicone resin formed as the top coat layer 15 differed from the acrylic silicone resin of the Comparative Example 1. The Tg after aging of its coating film was 57° C. In the results of the accelerated weather resistance test, the value of Δb when light irradiation was repeated using the Super UV Tester was 6.3 after 10 cycles, 11.1 after 20 cycles, 20.3 after 30 cycles, and 25.4 after 40 cycles. Namely, the value of Δb became larger as the number of cycles increased, and the appearance of the plated product 11 became increasingly yellow. In addition, in an evaluation of the adhesion between the top coat layer 15 and the silver plating layer 14 as determined by a taping test, satisfactory adhesion was demonstrated after 20 cycles of light irradiation since none of the 36 divided sections peeled off even when the taping test was repeated 10 times. However, in the case of 30 cycles of light irradiation or more, adhesion decreased to the extent that all of the divided sections peeled off after one round of the taping test.

On the other hand, as a result of immersing in hot water at 40° C. for 240 hours in a moisture resistance test, the appearance of the plated product 11 yellowed, and the value of Δb was 4.7. In addition, in an evaluation of the adhesion between top coat layer 15 and silver plating layer 14, satisfactory adhesion was maintained, with none of the 100 divided sections peeling off even when the taping test was repeated 10 times.

In Example 11, the Tg of the primary resin of the primary agent, namely the acrylic resin, was 10° C. higher than in Comparative Example 4. As a result, the Tg after aging of the acrylic silicone resin coating film formed as top coat layer 15 rose from 57° C. to 80° C. In the results of an accelerated weather resistance test in which light irradiation was repeated for 10 cycles using the Super UV Tester, the value of Δb decreased from 6.3 to 3.9. In this manner, a yellowing inhibitory effect was observed in Example 11 as compared with Comparative Example 4. In addition, in an evaluation of the adhesion between the top coat layer 15 and the silver plating layer 14, satisfactory adhesion was demonstrated, with none of the 36-divided sections peeling off even when the taping test was repeated 10 times.

According to the results of a moisture resistance test, the value of Δb decreased from 4.7 in Comparative Example 1 to 3.2, and a yellowing inhibitory effect was observed. In addition, in an evaluation of the adhesion between the top coat layer 15 and the silver plating layer 14, satisfactory adhesion was demonstrated, with none of the 100-divided sections peeling off even when the taping test was repeated 10 times.

In Example 12, the Tg of the acrylic resin was higher than that in Example 11 by 10° C. The Tg of the acrylic silicone resin coating film was 91° C. In the accelerated weather resistance test, the value of Δb was 3.5 after 10 cycles of light irradiation, and 6.3 after 20 cycles of light irradiation, and an improved yellowing inhibitory effect was observed. On the other hand, peeling of a portion of the divided sections occurred after 3 rounds of the taping test following 10 cycles of light irradiation and after one round of the taping test following 20 cycles of light irradiation. There was therefore observed to be room for improvement in adhesion in the case of applying this plated product 11 in locations subjected to intense exposure to ultraviolet rays.

In the results of the moisture resistance test, the value of Δb was 0.8, and yellowing was inhibited significantly, while in the taping test, none of the 100 divided sections were observed to peel off even when the test was repeated 10 times, thereby demonstrating satisfactory adhesion.

In Example 13, a different ultraviolet absorber from that used in Comparative Example 4 was added as an additive of the primary agent. Namely, a triazine-based ultraviolet absorber (amount added: 1.0 wt %) was added instead of the benzotriazole-based ultraviolet absorber (amount added: 0.7 wt %) used in Comparative Example 4. In the present example, the Tg after aging of the acrylic silicone resin coating film was 78° C. The value of Δb was 2.0 after 10 cycles of irradiation using the Super UV Tester, 4.1 after 20 cycles of irradiation, and 9.5 after 30 cycles of light irradiation, and a considerable improvement in weather resistance was observed. In addition, favorable adhesion was demonstrated between the top coat layer 15 and the silver plating layer 14 since none of the 36 divided sections peeled off up to 20 cycles of light irradiation even when the taping test was repeated 10 times. However, in the case of 30 cycles of light irradiation, some of the divided sections ended up peeling off after one round of the taping test, indicating that there is room for improvement in adhesion between the top coat layer 15 and the silver plating layer 14.

In the results of the moisture resistance test, the value of Δb was 2.5, and a considerable improvement in weather resistance was observed. Moreover, none of the 100-divided sections were observed to peel off even when the taping test was repeated 10 times, thereby indicating satisfactory adhesion.

In Example 14, the added amount of triazine-based ultraviolet absorber was increased from 0.7 wt % in Example 13 to 1.5 wt %. The Tg of the acrylic silicone resin coating film was 77° C. In the present example, the value of Δb was 1.3 after 10 cycles of light irradiation using the Super UV Tester, 4.2 after 20 cycles of light irradiation, and 9.5 after 30 cycles of light irradiation, and a considerable improvement in weather resistance was observed. In addition, as a result of evaluating adhesion between the top coat layer 15 and the silver plating layer 14 following light irradiation, none of the divided sections were observed to peel off following 30 cycles of light irradiation even when the taping test was repeated 10 times. Only a portion of the divided sections peeled off after two rounds of the peeling test even after light irradiation was repeated for 40 cycles.

In the results of the moisture resistance test, the value Δb was 1.3 and none of the divided sections were observed to peel off even when the taping test was repeated 10 times, thereby exhibiting a large improvement in yellowing inhibitory effect along with a high degree of adhesion.

In Example 15, the HALS was removed from the composition of the primary agent in Example 14, and the Tg of the acrylic silicone resin coating film was 74° C. The value of Δb was 0.3 after 10 cycles of light irradiation using the Super UV Tester, 2.5 after 20 cycles of light irradiation, and 5.5 after 30 cycles of light irradiation, and a considerable improvement in weather resistance was observed. On the other hand, adhesion between the top coat layer 15 and the silver plating layer 14 was indicated to be satisfactory since none of the 36-divided sections peeled off following 10 cycles of light irradiation when the taping test was repeated 10 times. However, in the case of 20 or more cycles of light irradiation, all of the divided sections peeled off after a single round of the taping test, and there was observed to be room for improvement in adhesion between the top coat layer 15 and the silver plating layer 14, and weather resistance in particular.

In the results of the moisture resistance test, the value of Δb was 0.4, and a considerable improvement in weather resistance was observed. Moreover, satisfactory adhesion was demonstrated since none of the 100 divided sections peeled off when the taping test was performed 10 times.

Next, as shown in Table 4, in Example 16, reducing sodium hydrogen sulfite was used in the silver mirror post-treatment step of step S53 of FIG. 2 based on the constitution of Example 15. In the present example, the value of Δb was 0.3 after 10 cycles of light irradiation using the Super UV Tester, 2.1 after 20 cycles of light irradiation, 2.8 after 30 cycles of light irradiation, and 3.5 after 40 cycles of light irradiation, and a considerable improvement in weather resistance was observed. In addition, as a result of evaluating adhesion between the top coat layer 15 and the silver plating layer 14 following light irradiation, none of the divided sections were observed to peel off after repeating 40 cycles of light irradiation even when the taping test was repeated 10 times.

In the results of the moisture resistance test, the value of Δb was 0.3, and none of the divided sections were observed to peel off even when the taping test was repeated 10 times, thereby demonstrating a large improvement in yellowing inhibitory effect along with a high degree of adhesion.

In Example 17, D-glucose was added to the first pre-treatment solution in the silver mirror pre-treatment step of step S41 of FIG. 2 based on the constitution of Example 16. In the present example, together with using an ammoniacal silver nitrate solution, in which silver oxide is dissolved, and adjusted that precipitated in 28 wt % aqueous ammonia, in the silver mirror coating step of step S51 of FIG. 2, hydrazine hydrate is used for the reducing solution.

In Example 17, the value of Δb was 0.3 after 10 cycles of light irradiation using the Super UV Tester, 1.4 after 20 cycles of light irradiation, 2.2 after 30 cycles of light irradiation, and 2.7 after 40 cycles of light irradiation, and an improvement effect on weather resistance was observed that surpassed that of Example 16. In addition, as a result of evaluating adhesion between the top coat layer 15 and the silver plating layer 14 following light irradiation, satisfactory adhesion was observed since none of the divided sections were observed to peel off after 40 cycles of light irradiation even when the taping test was repeated 10 times.

In the results of the moisture resistance test, the value of Δb was 0.3 and none of the divided sections were observed to peel off even when the taping test was repeated 10 times, thereby demonstrating a large improvement in yellowing inhibitory effect as well as a high degree of adhesion.

It should be apparent to those skilled in the art that the present invention may be embodied in many other specific forms without departing from the spirit or scope of the invention. Particularly, it should be understood that the invention may be embodied in the following forms.

A chlorine capturing agent such as an epoxy compound may be added to the base coating agent. In addition, TDI may be used for the curing agent of the base coating agent. In the case where an epoxy compound is added to the base coating layer, a urethane-based coating blended with, for example, alkyd polyol and polyester polyol should be used for the primary agent of the base coating agent.

The present invention may be embodied in a constitution in which a silver or other metal plating layer and a top coat layer 15 are layered either directly, or with a base coat layer 13 in between, onto the surface of base layer 12 having various shapes and composed of various materials such as rubber, glass, ceramics including porcelain, wood or paper. In addition, the base layer 12 may also be composed of a thermoplastic resin or thermosetting resin other than those listed in the embodiments of FIGS. 1 and 2.

The plated product 11 may also be composed with the base coat layer 13 omitted. It should be noted that in the case where the base coat layer 13 is omitted, the base coat coating step of step S30 is also omitted, and the silver plating layer 14 is formed directly on the surface of the base layer 12 by the plating pre-coating step of step S40.

The metal plating layer of the plated product 11 may also be composed of a metal other than silver. The silver plating layer 14 may be formed by, for example, electroplating or immersion plating, and is not limited to a method that uses a spray gun.

The catalyst used during formation of the silver plating layer 14 is not limited to that containing tin[II]. Catalysts that contain, for example, palladium[III], vanadium[IV], chromium[VI], iron[III], copper[II], arsenic[III], molybdenum[VII], ruthenium[II], ruthenium[III], rhodium[III], antimony[III], tellurium[IV], tellurium[VI], iodine[0], rhenium[III], rhenium[IV], rhenium[VI], rhenium[VII], osmium[IV], iridium[III], platinum[II], mercury[II], thallium[III], or bismuth[III] may be used for the catalyst. In addition, when these catalysts are not carried directly on the base layer 12 or the base coat layer 13, a co-catalyst such as tin[II] may be carried on the surface of the base layer 12 or base coat layer 13 prior to carrying on the catalyst so as to carry the catalyst by replacing that co-catalyst.

The present examples and embodiments are to be considered as illustrative and not restrictive and the invention is not to be limited to the details given herein, but may be modified within the scope and equivalence of the appended claims.

1. A plated product comprising:
a substrate layer;
a metal plating layer located on the substrate layer;
a covering layer for covering a surface of the metal plating layer, wherein the covering layer is consisted of an acrylic silicone coating that includes a primary agent and a curing agent, wherein a coating film is formed by causing the primary agent and the curing agent to react while the acrylic silicone coating is applied to the metal plating layer, wherein, when the coating film is aged by allowing to stand for 240 hours at a normal temperature and a humidity range of 20% to 70%, the range of the glass transition temperature of the coating film is between 70° C. and 120° C. inclusive.

2. The plated product according to claim 1, wherein the range of the glass transition temperature of a primary resin that is included in the primary agent is between 35° C. and 80° C. inclusive.

3. The plated product according to claim 2, wherein the range of the amount of amine in the primary resin is between 5 wt % and 20 wt % inclusive.

4. The plated product according to claim 1, wherein the curing agent includes a silane coupling agent and alkoxysilane, wherein the silane coupling agent is expressed as X—R′—O—R″—Si(OR)₃ (wherein R′ and R″ each are an alkyl group), wherein the position of X is an epoxy group, and the position of OR is an alkoxy group, and wherein the range of the ratio of the alkoxysilane relative to the silane coupling agent is between 0.2 and 15 inclusive.

5. The plated product according to claim 1, wherein the primary agent includes a contraction relaxant that alleviates contraction during curing of the coating film.

6. The plated product according to claim 1, wherein the primary agent includes an ultraviolet absorber that does not have a hydroxyl group in its molecule.

7. The plated product according to claim 1, wherein the primary agent includes a triazine-based ultraviolet absorber.

8. The plated product according to claim 6, wherein the primary agent includes a hindered amine light stabilizer that does not have a hydroxyl group in its molecule.

9. The plated product according to claim 7, wherein the primary agent includes a hindered amine light stabilizer that does not have a hydroxyl group in its molecule.

10. A plated product comprising:
a substrate layer;
a metal plating layer located on the substrate layer, wherein a solution including a monovalent alkyl alcohol, or a reducing solution is applied to the metal plating layer;
a covering layer for covering a surface of the metal plating layer, wherein the covering layer is consisted of an acrylic silicone coating that includes a primary agent and a curing agent, wherein a coating film is formed by causing the primary agent and the curing agent to react while the acrylic silicone coating is applied to the metal plating layer, wherein the primary agent and the curing agent are selected such that the range of the glass transition temperature of the coating film is between 70° C. and 120° C. inclusive when the coating film is aged by allowing to stand for 240 hours at a normal temperature and a humidity range of 20% to 70%.

11. The plated product according to claim 10, wherein the range of the glass transition temperature of a primary resin that is included in the primary agent is between 35° C. and 80° C. inclusive.

12. The plated product according to claim 11, wherein the range of the amount of amine in the primary resin is between 5 wt % and 20 wt % inclusive.

13. The plated product according to claim 10, wherein the curing agent includes a silane coupling agent and alkoxysilane, wherein the silane coupling agent is expressed as X—R′—O—R″—Si(OR)₃ (wherein R′ and R″ each are an alkyl group), wherein the position of X is an epoxy group, and the position of OR is an alkoxy group, and wherein the range of the ratio of the alkoxysilane relative to the silane coupling agent is between 0.2 and 15 inclusive.

14. The plated product according to claim 10, wherein the primary agent includes a contraction relaxant that alleviates contraction during curing of the coating film.

15. The plated product according to claim 10, wherein the primary agent includes an ultraviolet absorber that does not have a hydroxyl group in its molecule.

16. The plated product according to claim 10, wherein the primary agent includes a triazine-based ultraviolet absorber.

17. The plated product according to claim 15, wherein the primary agent includes a hindered amine light stabilizer that does not have a hydroxyl group in its molecule.

18. The plated product according to claim 16, wherein the primary agent includes a hindered amine light stabilizer that does not have a hydroxyl group in its molecule.

19. A production method of a plated product:
preparing a substrate layer;
forming a metal plating layer on a substrate of the substrate layer;
applying an acrylic silicone coating including a primary agent and a curing agent on a surface of the metal plating layer, wherein a coating film is formed by causing the primary agent and the curing agent to react, wherein the coating film is aged by allowing to stand for 240 hours at a normal temperature and a humidity range of 20% to 70% such that the range of the glass transition temperature of the coating film is between 70° C. and 120° C. inclusive.
